(19) United States
(12) Patent Application Publication
(10) Pub. No.: US 2025/0198323 A1
(43) Pub. Date: Jun. 19, 2025

(54) EXHAUST MANIFOLD

(71) Applicant: CUMMINS INC., Columbus, IN (US)

(72) Inventors: Nilesh Anil Ghodke, Ahmednagar (IN); Girish Jaiprakash Kulkarni, Pune (IN)

(73) Assignee: CUMMINS INC., Columbus, IN (US)

(21) Appl. No.: 18/979,431

(22) Filed: Dec. 12, 2024

(30) Foreign Application Priority Data
Dec. 15, 2023 (IN) 202341085944
Dec. 3, 2024 (IN) 202341085944

(51) Int. Cl. F01N 13/10

(52) U.S. Cl. CPC F01N 13/10

(57) ABSTRACT

An internal combustion engine includes a cylinder head with an exhaust manifold coupled to the cylinder head and a turbocharger coupled to the exhaust manifold. The exhaust manifold comprises one or more exhaust passages in fluid receiving communication with one or more cylinders of the internal combustion engine. The exhaust manifold further comprises a flange having one or more openings in fluid receiving communication with the one or more exhaust passages. The openings are configured to increase thermomechanical failure life in the exhaust manifold flange.

### CROSS-REFERENCE TO RELATED APPLICATIONS

The present application claims priority to Indian Provisional Patent Application No. 202341085944, entitled “An Exhaust Manifold,” filed Dec. 15, 2023, and Indian Non-Provisional patent application No. 202341085944, filed Dec. 3, 2024, the contents of which are incorporated herein by reference.

### TECHNICAL FIELD

The present application relates generally to exhaust manifold assemblies of internal combustion engines.

### BACKGROUND

An internal combustion engine may include a cylinder head with an exhaust manifold coupled to the cylinder head. A turbocharger may be coupled to a flange of the exhaust manifold. Gases are fed through the exhaust manifold from the cylinder head, and then through the turbocharger.

### SUMMARY

In one set of embodiments, an exhaust manifold comprises an exhaust manifold flange, a first exhaust passage extending from the exhaust manifold flange, and a second exhaust passage extending from the exhaust manifold flange. The first exhaust passage has a first exhaust passage first end and a first exhaust passage second end. The first exhaust passage first end is in fluid communication with the exhaust manifold flange via a first substantially circular opening defined in the exhaust manifold flange. The second exhaust passage has a second exhaust passage first end and a second exhaust passage second end. The second exhaust passage first end is in fluid communication with the exhaust manifold flange via a second substantially circular opening defined in the exhaust manifold flange.

In another set of embodiments, an exhaust manifold comprises an exhaust manifold flange, a first exhaust passage extending from the exhaust manifold flange, and a second exhaust passage extending from the exhaust manifold flange. The first exhaust passage has a first exhaust passage first end and a first exhaust passage second end. The first exhaust passage first end is in fluid communication with the exhaust manifold flange via a first opening defined in the exhaust manifold flange. The first opening has a first opening planar side, a first opening second planar side substantially parallel to the first opening first planar side, and a first opening first curved side and a first opening second curved side each extending between the first opening first planar side and the first opening second planar side. The second exhaust passage has a second exhaust passage first end and a second exhaust passage second end. The second exhaust passage first end is in fluid communication with the exhaust manifold flange via a second opening defined in the exhaust manifold flange. The second opening has a second opening first planar side, a second opening second planar side substantially parallel to the second opening first planar side, and a second opening first curved side and a second opening second curved side each extending between the second opening first planar side and the second opening second planar side.

### BRIEF DESCRIPTION OF THE FIGURES

The details of one or more implementations are set forth in the accompanying drawings and the description below. Other features, aspects, and advantages of the disclosure will become apparent from the description, the drawings, and the claims, in which:

FIG. 1 is a perspective view of an example internal combustion engine system including an exhaust manifold;

FIG. 2 is a bottom view of a portion of the exhaust manifold of the internal combustion engine system of FIG. 1;

FIG. 3 shows a first detail view of the exhaust manifold flange of the exhaust manifold of FIG. 2; and

FIG. 4 shows a second detail view of the exhaust manifold flange of the exhaust manifold of FIG. 2.

It will be recognized that the Figures are schematic representations for purposes of illustration. The Figures are provided for the purpose of illustrating one or more implementations with the explicit understanding that the Figures will not be used to limit the scope or the meaning of the claims.

### DETAILED DESCRIPTION OF VARIOUS EMBODIMENTS

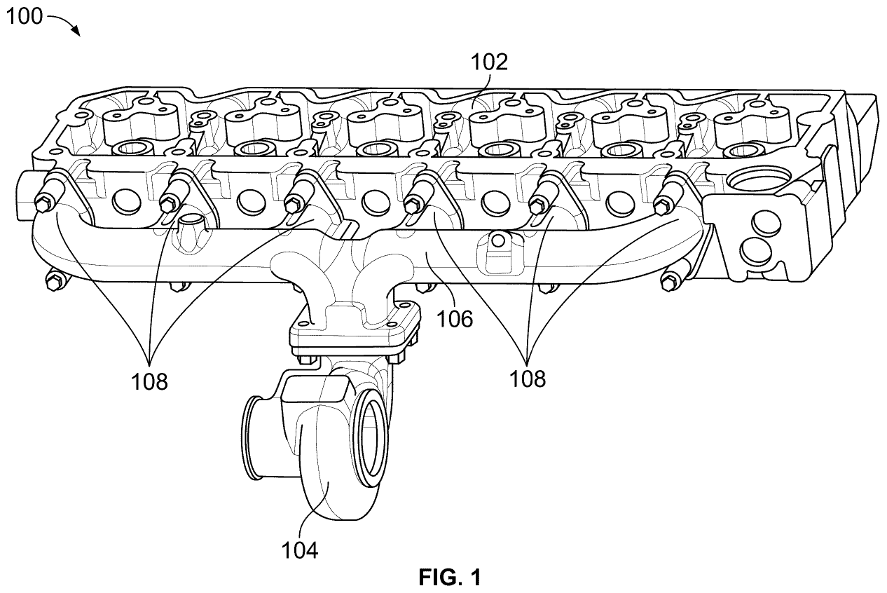

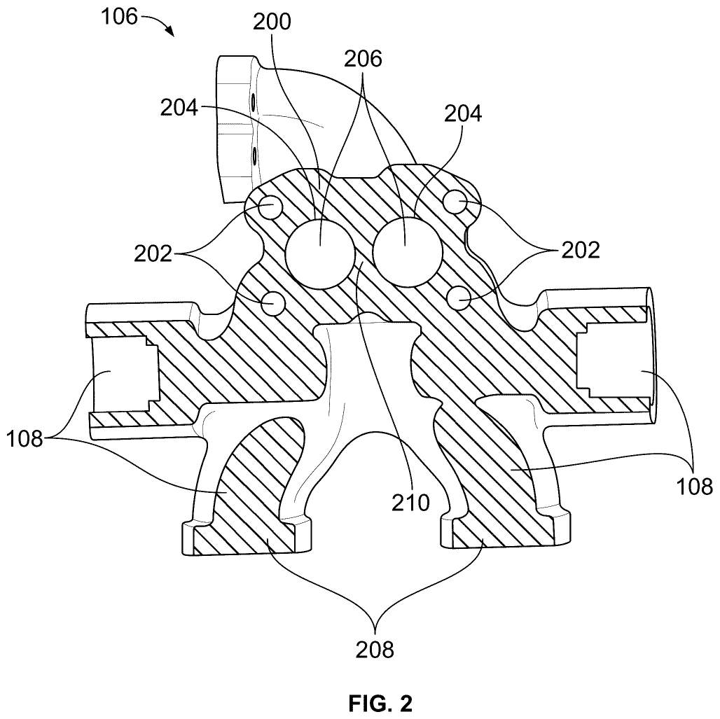

As shown in FIGS. 1-4, an exhaust manifold 106 (e.g., outlet manifold, etc.) comprises an exhaust manifold flange 200 (different examples of which are shown in FIGS. 2-5), a first exhaust passage 108 extending from the exhaust manifold flange 200, and a second exhaust passage 108 extending from the exhaust manifold flange 200. The first exhaust passage 108 has a first exhaust passage first end 206 and a first exhaust passage second end 208. The first exhaust passage first end 108 is in fluid communication with the exhaust manifold flange 200 via a first substantially circular opening 300 defined in the exhaust manifold flange 200. The second exhaust passage 108 has a second exhaust passage first end 206 and a second exhaust passage second end 208. The second exhaust passage first end 206 is in fluid communication with the exhaust manifold flange 200 via a second substantially circular opening 300 defined in the exhaust manifold flange 200.

The exhaust manifold 106 is part of an internal combustion engine system 100. The internal combustion engine system 100 may be, for example, a diesel internal combustion engine system, a gasoline internal combustion engine system, a hybrid internal combustion engine system, etc. The internal combustion engine system 100 is configured to combust a fuel (e.g., diesel fuel, gasoline, etc.) to produce energy that may be utilized by various outputs. For example, the internal combustion engine system 100 may produce energy that is utilized to drive a movement member (e.g., wheel, tread, propeller, impeller, turbine, rotor, etc.) or power a generator.

The internal combustion engine system 100 includes a cylinder head 102. The cylinder head 102 is coupled to a cylinder block (not shown). The cylinder block houses a plurality of engine cylinders for the internal combustion engine 100. The number of engine cylinders may vary depending upon the particular engine arrangement (e.g., two engine cylinders, four engine cylinders, five engine cylinders, six engine cylinders, seven engine cylinders, eight engine cylinders, nine engine cylinders, ten engine cylinders, twelve engine cylinders, fourteen engine cylinders, etc.).

The internal combustion engine system 100 depicted in FIG. 1 also includes a turbocharger 104. The turbocharger 104 is coupled to the cylinder head 102 and receives exhaust gas from the cylinder head 102.

The internal combustion engine system 100 also includes the exhaust manifold 106 comprising a plurality of the exhaust passages 108, as shown in FIG. 1. The exhaust manifold 106, portions of examples of which are shown in FIGS. 2-4, is coupled to a second side (e.g., hot side, exhaust side, etc.) of the cylinder head 102 and is configured to receive exhaust gas from the cylinder head 102.

Turning now to FIG. 2, a bottom view of the exhaust manifold 106 is shown. The exhaust manifold 106 is coupled to the turbocharger 104 via the exhaust manifold flange 200. The exhaust manifold flange 200 couples to a turbocharger flange (not shown). Mounting bosses 202 on the exhaust manifold flange 200 facilitate coupling of the exhaust manifold flange 200 to the turbocharger flange. The exhaust manifold flange 200 and the turbocharger flange may be coupled using bolts, screws, v-band clamps, etc.

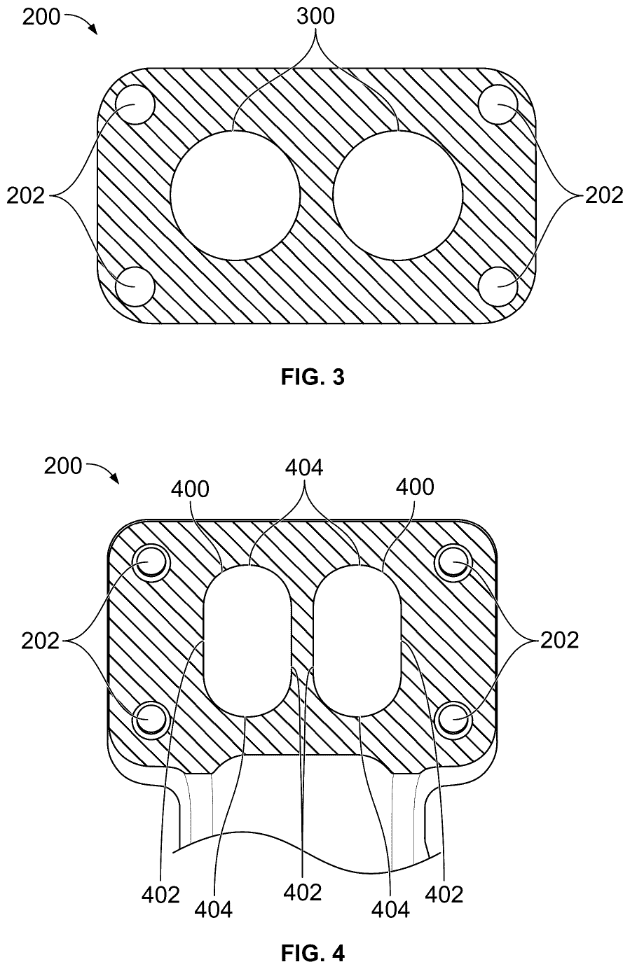

The exhaust manifold flange 200 defines one or more exhaust manifold flange openings 204, different embodiments of which are shown in FIGS. 3-4. Each exhaust manifold flange opening 204 is in fluid receiving communication with the exhaust passage first end 206. The exhaust passage first end 206 is in fluid receiving communication with one or more of the exhaust passage second ends 208 that receive exhaust from the plurality of engine cylinders of the internal combustion engine 100. Certain exhaust passage shapes at a region near the exhaust manifold flange 200 of the exhaust manifold 106 can improve thermomechanical failure life for the region near the exhaust manifold flange 200.

As shown in FIGS. 2-4, the cross-section of each exhaust manifold flange opening 204 remains constant or substantially constant within the exhaust manifold flange 200. In other embodiments, the cross-sections of each exhaust manifold flange opening 204 may be non-uniform within the exhaust manifold flange 200.

The exhaust manifold flange openings 204 are separated by a dividing wall 210. The exhaust manifold flange openings 204 are variously configured to increase thermomechanical failure life for the dividing wall 210 and the portion of the exhaust manifold 200 flange defining the exhaust manifold flange openings 204. The dividing wall 210 may at least in part define one or more of the exhaust manifold flange openings 204.

In the embodiment of FIG. 3, the exhaust manifold flange 200 defines a pair of the substantially circular openings 300. The substantially circular openings 300 may or may not be exactly circular in shape and may or may not have substantially the same diameter. The dividing wall 210 may at least in part define one or more of the substantially circular openings 300.

At a location distal from the exhaust passage first end 206, each exhaust passage 108 may have a cross-section that is non-circular, or else differently shaped than the cross-section of the substantially circular openings 300. The cross-sections of each exhaust passage 108 taken at a plurality of locations between the exhaust passage first end 206 and the exhaust passage second end 208 may be non-uniform. Each exhaust passage 108 may also have a different or unique cross-section from other exhaust passages 108.

Turning now to FIG. 4, the exhaust manifold 106 comprises the exhaust manifold flange 200, the first exhaust passage 108 extending from the exhaust manifold flange 200, and the second exhaust passage 108 extending from the exhaust manifold flange 200. The first exhaust passage 108 has the first exhaust passage first end 206 and the first exhaust passage second end 208. The first exhaust passage first end 108 is in fluid communication with the exhaust manifold flange 200 via a first opening 400 defined in the exhaust manifold flange 200. The second exhaust passage 108 has the second exhaust passage first end 206 and the second exhaust passage second end 208. The second exhaust passage first end 206 is in fluid communication with the exhaust manifold flange 200 via a second opening 400 defined in the exhaust manifold flange 200. The first opening 400 has a first opening first planar side 402, a first opening second planar side 402 substantially parallel to the first opening first planar side 402, and a first opening first curved side 404 and a first opening second curved side 404 each extending between the first opening first planar side 402 and the first opening second planar side 402. The second opening 400 has a second opening first planar side 402, a second opening second planar side 402 substantially parallel to the second opening first planar side 402, and a second opening first curved side 404 and a second opening second curved side 404 each extending between the second opening first planar side 402 and the second opening second planar side 402.

Each curved side 404 has a radius of curvature that is substantially the same. The curved sides 404 are substantially semicircular in shape, but may take other shapes or have varying radii.

The exhaust manifold flange 200 defines a pair of openings 400. Each opening 400 is substantially capsule-shaped, but may take other shapes, including but not limited to, an elliptical, oval, triangular, rectangular, hexagonal, pentagonal, or other shape.

While this specification contains many specific implementation details, these should not be construed as limitations on the scope of what may be claimed but rather as descriptions of features specific to particular implementations. Certain features described in this specification in the context of separate implementations can also be implemented in combination in a single implementation. Conversely, various features described in the context of a single implementation can also be implemented in multiple implementations separately or in any suitable subcombination. Moreover, although features may be described as acting in certain combinations and even initially claimed as such, one or more features from a claimed combination can, in some cases, be excised from the combination, and the claimed combination may be directed to a subcombination or variation of a subcombination.

As utilized herein, the term “generally” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

The term “coupled” and the like, as used herein, mean the joining of two components directly or indirectly to one another. Such joining may be stationary (e.g., permanent) or moveable (e.g., removable or releasable). Such joining may be achieved with the two components or the two components and any additional intermediate components being integrally formed as a single unitary body with one another, with the two components, or with the two components and any additional intermediate components being attached to one another.

It is important to note that the construction and arrangement of the various systems shown in the various example implementations is illustrative only and not restrictive in character. All changes and modifications that come within the spirit and/or scope of the described implementations are desired to be protected. It should be understood that some features may not be necessary, and implementations lacking the various features may be contemplated as within the scope of the disclosure, the scope being defined by the claims that follow. When the language “a portion” is used, the item can include a portion and/or the entire item unless specifically stated to the contrary.

Also, the term “or” is used, in the context of a list of elements, in its inclusive sense (and not in its exclusive sense) so that when used to connect a list of elements, the term “or” means one, some, or all of the elements in the list. Conjunctive language such as the phrase “one or more of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

We claim:

1. An exhaust manifold, comprising:
an exhaust manifold flange;
a first exhaust passage extending from the exhaust manifold flange and having a first exhaust passage first end and a first exhaust passage second end, the first exhaust passage first end in fluid communication with the exhaust manifold flange via a first opening defined in the exhaust manifold flange; and
a second exhaust passage extending from the exhaust manifold flange and having a second exhaust passage first end and a second exhaust passage second end, the second exhaust passage first end in fluid communication with the exhaust manifold flange via a second opening defined in the exhaust manifold flange, wherein the second opening is substantially the same shape as the first opening.

2. The exhaust manifold as claimed in claim 1, wherein the first opening and the second opening have substantially the same diameter.

3. The exhaust manifold as claimed in claim 1, wherein a cross section of the first exhaust passage at a location distal from the first exhaust passage first end is non-circular.

4. The exhaust manifold as claimed in claim 1, wherein a cross section of the second exhaust passage at a location distal from the second exhaust passage first end is non-circular.

5. The exhaust manifold as claimed in claim 1, further comprising a dividing wall positioned between the first exhaust passage and the second exhaust passage.

6. The exhaust manifold as claimed in claim 5, wherein the dividing wall at least in part defines the first opening.

7. The exhaust manifold as claimed in claim 5, wherein the dividing wall at least in part defines the second opening.

8. The exhaust manifold as claimed in claim 1, wherein a cross-section of the first exhaust passage is non-uniform along a length of the first exhaust passage.

9. The exhaust manifold as claimed in claim 1, wherein a cross-section of the second exhaust passage is non-uniform along a length of the second exhaust passage.

10. The exhaust manifold as claimed in claim 1, wherein the first opening and the second opening are substantially circular.

11. The exhaust manifold as claimed in claim 1, wherein a cross-section of the first opening remains substantially constant within the exhaust manifold flange.

12. The exhaust manifold as claimed in claim 11, wherein a cross-section of the second opening remains substantially constant within the exhaust manifold flange.

13. An exhaust manifold, comprising:
an exhaust manifold flange;
a first exhaust passage extending from the exhaust manifold flange and having a first exhaust passage first end and a first exhaust passage second end, the first exhaust passage first end in fluid communication with the exhaust manifold flange via a first opening defined in the exhaust manifold flange, the first opening having:
a first opening first planar side;
a first opening second planar side substantially parallel to the first opening first planar side; and
a first opening first curved side and a first opening second curved side each extending between the first opening first planar side and the first opening second planar side; and
a second exhaust passage extending from the exhaust manifold flange and having a second exhaust passage first end and a second exhaust passage second end, the second exhaust passage first end in fluid communication with the exhaust manifold flange via a second opening defined in the exhaust manifold flange, the second opening having:
a second opening first planar side;
a second opening second planar side substantially parallel to the second opening first planar side; and
a second opening first curved side and a second opening second curved side each extending between the second opening first planar side and the second opening second planar side.

14. The exhaust manifold as claimed in claim 13, wherein one or more of the first opening first curved side, the first opening second curved side, the second opening first curved side, and the second opening second curved side are substantially semicircular in shape.

15. The exhaust manifold as claimed in claim 13, wherein the exhaust manifold flange comprises a dividing wall positioned between the first opening and the second opening.

16. The exhaust manifold as claimed in claim 13, wherein a cross-section of the first exhaust passage is shaped differently from a cross-section of the first opening.

17. The exhaust manifold as claimed in claim 13, wherein a cross-section of the second exhaust passage is shaped differently from a cross-section of the second opening.
